(19) United States
(12) Patent Application Publication
(10) Pub. No.: US 2010/0280492 A1
(43) Pub. Date: Nov. 4, 2010

(54) Delivery System and Method Therefor

(76) Inventor: Tiffany Krumins, Auburn, GA (US)

Correspondence Address: Jerome E. Sacks, P.O. Box 601, Lexington, MA, 02420, US

(21) Appl. No.: 12/434,304

(22) Filed: May 1, 2009

(51) Int. Cl. A61J 7/00; B67D 5/22

(52) U.S. Cl. 604/516; 222/23; 222/420; 222/30; 604/77

(57) ABSTRACT

A delivery system includes a material delivery system, wherein the delivery system is adapted to dispense a flowable material. Also included is a cover adapted to at least partially cover the material delivery system, and a messaging system adapted to play a message upon activation thereof.

### BACKGROUND OF THE INVENTION

The present invention relates to a delivery system generally, and more specifically to a delivery system for a flowable material and the like, and a method therefor.

Often it is desirable and at times necessary to orally administer medicine to, for example, infants and small children. As such, many pharmaceuticals and drugs for children are provided in liquid form to facilitate this oral administration. However, often these medicines are difficult to administer and for various reasons children are reluctant (or refuse) to take them and as such, dispensing these medications to an unwilling child can result in frustration to both the child and the administrator. Further yet, this reluctance can result in the child rejecting all or part of the medication and thereby result in the child not taking the entire does. Consequently, the child is left partially dosed, usually comprising an unknown dose having been taken, as well as typically results in a mess associated with the untaken, for example spilled, medication.

The task of providing medicine to a small child or infant, especially when the latter is sick or otherwise in an uncomfortable state, is often a frustrating experience for both the child and the person attempting to administer the medication. For example, when utilizing a spoon, the spoon containing the medicine may be rejected and often, due to the urgency of the occasion, force is utilized. This, aside from making the situation more stressful, may also result injury if excessive force is used. Further making the delivery of the medication difficult is that often a child, and especially a sick infant, refuse to eat or drink and hence, efforts to introduce oral medicine either directly or mixing with food, may result in failure.

Accordingly, a need exists for novel systems and methods which have, among other advantages, the ability to increase the desire of a recipient to be administered a flowable product, and increasing the effectiveness thereof while reducing the stress associated therewith. For example, and in one embodiment only, it is an object of the invention to provide an apparatus for orally dispensing fluids to a small child and particularly, to provide a system for delivery of flowable product which a child will eagerly accept, as well as provides for ease of use and cleaning.

Therefore, a delivery system that solves the aforementioned disadvantages and having the aforementioned advantages is desired.

### SUMMARY OF THE PRESENT INVENTION

The aforementioned drawbacks and disadvantages of these former delivery systems have been identified and a solution is set forth herein by the inventive delivery system which includes a delivery system for providing a flowable material comprising, a material delivery system, wherein the delivery system is adapted to dispense a flowable material. Also included is a cover adapted to at least partially cover the material delivery system, and a messaging system adapted to play a message.

Another aspect of the present invention includes a medicinal delivery system for a patient comprising a medicinal delivery system adapted to dispense a flowable material. Additionally, a cover is included which is adapted to removably and at least partially cover the medicinal delivery system. Further included is a messaging system adapted to play a prerecorded message upon activation thereof, wherein the messaging system is disposed on one of the delivery system or the cover.

In another aspect of the present invention, a medicinal delivery system for children comprises: a medicine dropper, wherein the medicine dropper is adapted to dispense a predefined amount of liquid into a child's mouth upon activation; a cover, wherein the cover is at least partially and removably disposed over the medicine dropper, the cover further including a mouthpiece; and a messaging system, wherein the messaging system is adapted to play a prerecorded audio message upon activation thereof, the messaging system disposed at least partially within the cover; wherein further a user may activate the messaging system, thereby playing the prerecorded audio message, and dispense the predefined amount of liquid, through the mouthpiece of the cover, and into the child's mouth.

And still in another aspect of the present invention, a medicinal delivery system for children comprises a medicine dropper adapted to dispense a predefined amount of liquid into a child's mouth upon activation thereof, and a cover adapted to be removably disposed over the medicine dropper, wherein the medicine dropper is adapted to be removably supported within the cover.

And still further, another aspect of the present invention includes a method for providing a flowable material to a patient, the method comprising: providing a delivery system including a medicinal delivery system adapted to dispense a flowable material, and a cover adapted to at least partially cover the medicinal delivery system; filling the medicinal delivery system with a predefined amount of a flowable material; disposing the medicinal delivery system at least partially within the cover; and dispensing the flowable material to the patient.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. To wit, the delivery system of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U.S. Patent and Trademark Office and the public generally, and especially the scientists, engineers, and practitioners in the art who are not familiar with the patent or legal terms of phraseology, to learn quickly, from a cursory inspection, the nature of the technical disclosure of the application. Accordingly, the Abstract is intended to define neither the invention nor the application, which is only measured by the claims, nor is it intended to be limiting as to the scope of the invention in any way.

These and other objects, along with the various features and structures that characterize the invention, are pointed out with particularity in the claims annexed to and forming a part of this disclosure. For a better understanding of the delivery system of the present disclosure, its advantages, and the specific objects attained by its uses, reference should be made to the accompanying drawings and descriptive matter in which there are illustrated and described the preferred embodiments of the invention.

As such, while embodiments of the delivery system are herein illustrated and described, it is to be appreciated that various changes, rearrangements, and modifications may be made therein, without departing from the scope of the invention as defined by the claims.

### BRIEF DESCRIPTION OF THE DRAWINGS

As a compliment to the description and for better understanding of the specification presented herein, 3 pages of drawings are disclosed with an informative, but not limiting, intention.

FIG. 1 is a perspective view of an embodiment of the delivery system of the present invention;

FIG. 2 is a rear view of the delivery system of FIG. 1;

FIG. 3 is a partial sectional side view of the delivery system of FIG. 1 illustrating a delivery system within an embodiment of a cover;

FIG. 4 is a view of the delivery system of FIG. 3 illustrating a partially inserted delivery system;

FIG. 5 is a partial sectional side view of a cover of the delivery system.

### DETAILED DESCRIPTION OF THE PREFERRED EMBODIMENT

The best mode for carrying out the invention is presented in terms of the preferred embodiment, wherein similar referenced characters designate corresponding features throughout the several figures of the drawings.

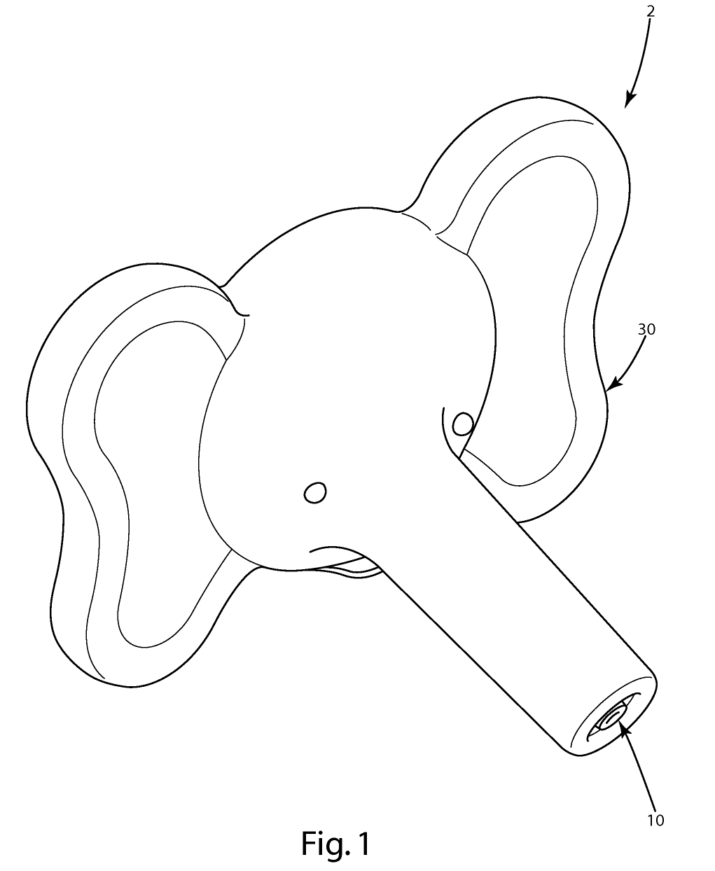

For purposes of description herein, the terms “upper”, “lower”, “right”, “left”, “rear”, “front”, “vertical”, “horizontal”, and derivatives thereof, shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

As used herein, the term flowable material is meant to be used and defined in its broad and ordinary sense. To wit, a material that able to flow. For example, a liquid, gas, powder, or the like. Of course, this is merely an example and not meant to be limiting in any manner.

As used herein, the term medicinal is meant to be used and defined in its broad and ordinary sense. To wit, a material or substance that is used for any medicinal purpose and may include, for example only, vitamins, drugs, herbs, or the like. Of course, this is exemplary and also not meant to be limiting in any manner.

As used herein, the term message or messaging system is meant to be used and defined in its broad and ordinary sense. To wit, a system that can store, record, and/or play a message and, for example only, may include an electronic device for storing, recording and playing audio or video messages; the message comprising anything stored, recorded or played. Of course, this is exemplary and not meant to be limiting in any manner.

In a broader sense, it is desirable and at times often necessary to orally administer medicine to, for example, infants and small children. As such, many pharmaceuticals and drugs for children are provided in liquid form to facilitate this oral administration. However, often these medicines are difficult to administer and for various reasons children are reluctant (or refuse) to take them and as such. Further yet, this reluctance can result in the child rejecting all or part of the medication and thereby result in the child not taking the entire does. Consequently, the child is left partially dosed, usually comprising an unknown dose having been taken.

The task of providing medicine to a small child or infant, especially when the latter is sick or otherwise in an uncomfortable state, is often a frustrating experience for both the child and the person attempting to administer the medication. Further making the delivery of the medication difficult is that often a child, and especially a sick infant, refuse to eat or drink and hence, efforts to introduce oral medicine may result in failure.

Accordingly, a need exists for novel systems and methods which have, among other advantages, the ability to increase the effectiveness of administering a flowable product and therefore, a delivery system that solves the aforementioned disadvantages and having the aforementioned advantages is disclosed herein.

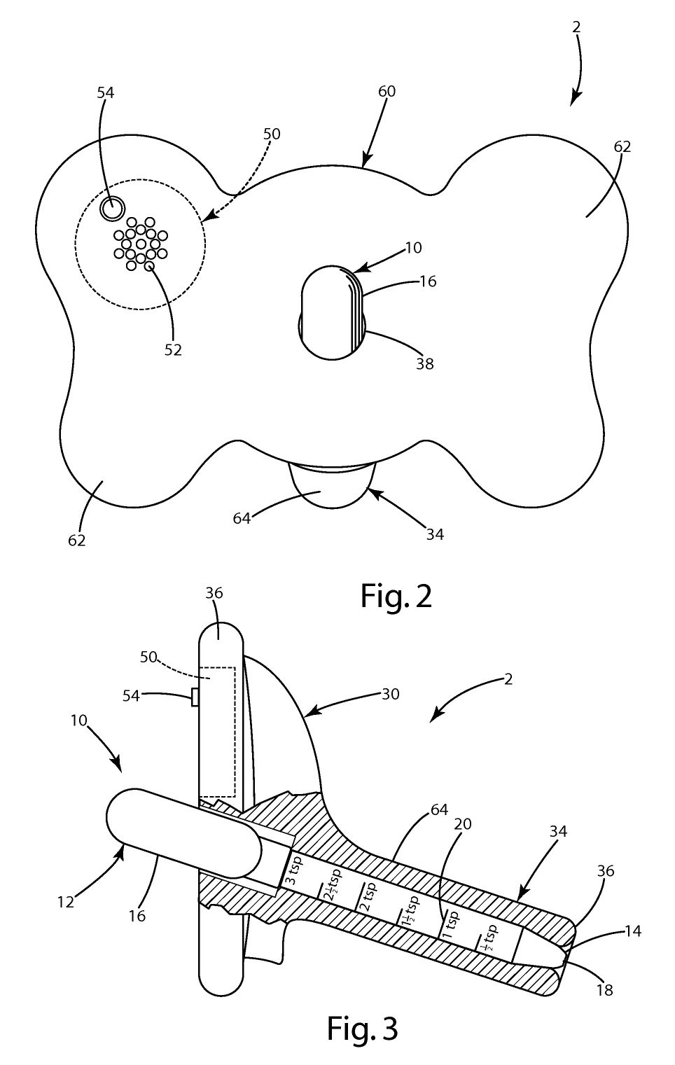

The disadvantages and drawbacks of the prior art are overcome through the delivery system of the present invention, wherein one preferred embodiment is disclosed in FIGS. 1-5. Referring now to FIG. 1, there is shown a perspective front view of one embodiment of a delivery system 2 for providing a flowable material, wherein FIG. 2 illustrates a rear view thereof. The delivery system 2 includes a material delivery system 10 which is configured to dispense any flowable material. Further included is a cover 30 which, at least partially, covers the material delivery system 10, and a messaging system 50 which may play a message when activated.

Material delivery system 10 may comprise any known delivery system for providing a flowable material. As illustrated in FIG. 3, one embodiment comprises a medicine dropper 12 which is normally utilized to measure, hold, and otherwise retain a liquid. For example, a medical liquid. As is known in the art, medicine dropper 12 generally includes a stem 14 and a bulb 16. Stem 14 includes a first end 18 and an opposite end for receiving bulb 16. Stem 14 may further include one or more gradations or calibrations 20 for illustrating a specific amount of fluid contained therein and as such, a measured and predefined amount of fluid may be contained therein.

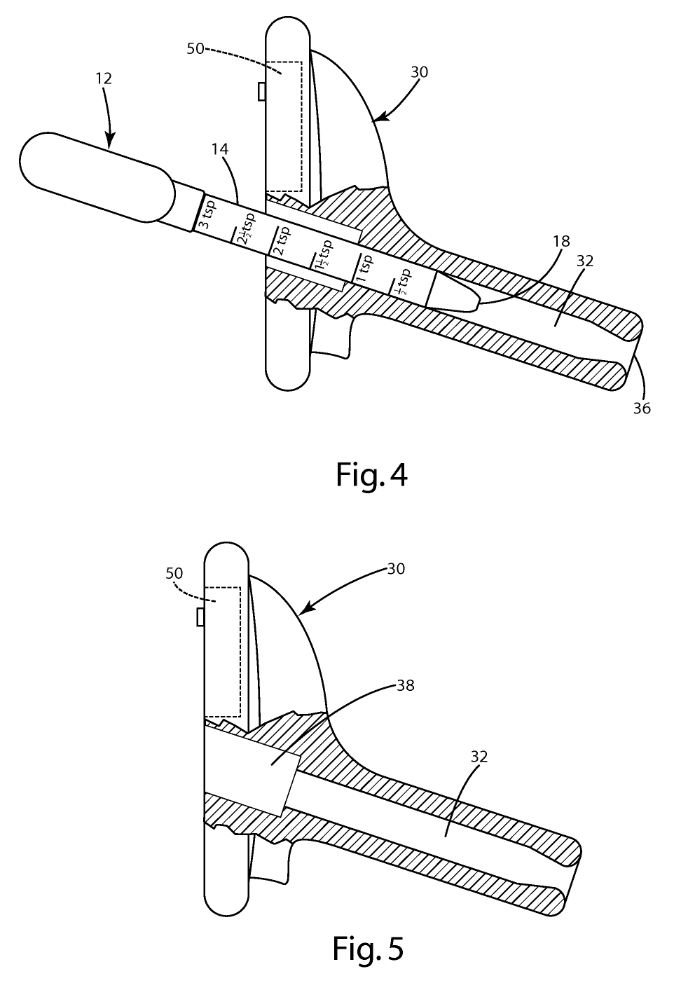

As illustrated by FIGS. 3-4, material delivery system 10 may be partially or fully disposed within Cover 30. For example, in the embodiment illustrated by FIG. 3, medicine dropper 12 is at least partially disposed within or covered by cover 30. More particularly, this embodiment includes the stem 14 which is completely disposed within, fully covered by, and wholly enclosed by cover 30, whereby the stem 14 is disposed within and supported by an elongated channel 32. In the illustrated embodiment, elongated channel 32 is disposed within a mouthpiece 34 and comprises a first end 36. Further illustrating this particular embodiment, medicine dropper first end 18 may be positioned, disposed, or otherwise adjacent with mouthpiece first end 36.

Of course, alternate embodiments may include material delivery system 10, and more particularly stem 14 of medicine dropper 12, which is partially covered, as opposed to fully covered and further, material delivery system 10, medicine dropper 12, and stem 14 may be removable from cover 30 (FIGS. 4-5), or may be integral therewith. In the particular embodiment illustrated, cover 30 also includes an orifice 38 for at least partially receiving bulb 16.

As illustrated by FIGS. 2-5, delivery system 2 may further comprise a messaging system 50. As is generally known in the art, messaging system 50 may include and electronic device that can store, play, and record a message. For example, an audio recording device. In this particular embodiment, the messaging system 50 may be disposed on or within cover 30 and if disposed within cover 30, may comprise a series of openings 52 for the audio to be transmitted therethrough. Additionally, messaging system 50 may comprise an activation device, for example a button 54, for activating the messaging system 50 when desired by the user or administrator.

Of course, the audio message may be pre-provided (e.g., pre-recorded), or recorded by the end-user and further, it is also envisioned that other messaging devices could be utilized. For example only, a video messaging device (with accompanying display) could also be used.

In one particular embodiment, and referring to FIGS. 1-5, the delivery system 2 comprises a medicine dropper 12 which is receivingly disposed within the elongated channel 32 in cover 30. Through this system, a flowable material, for example a medicinal fluid, may be provided to a patient (e.g., a child).

While delivery system 2 may comprise an integral material delivery system 10 and cover 30, in this particular embodiment medicine dropper 12 is removable and may be removed from cover 30 in order to be prepared, filled, or cleaned.

In use then, and describing one embodiment which includes a removable medicine dropper 12, with medicine dropper 12 being disassociated with cover 30, delivery system 2 is initially prepared by filling dropper 12 with a determined amount (dose) of fluid. When filled, dropper 12, and more particularity stem 14, is inserted into channel 32 and in this embodiment, is fully seated therein (FIG. 3). With delivery system 2 now comprising cover 30 and medicine dropper 12, delivery system 2 is ready to administer the flowable product.

One primary characteristic of cover 30 is the configuration thereof so as to be enticing or distracting to the patient. For example only, the illustrated embodiment includes a cover 30 which is configured to resemble a friendly or non threatening elephant. Of course, any number of alternate configurations could also be used.

In continuing with the description of this particular embodiment, the administrator or user will handle delivery system 2 through, for example, a main body portion 60 and one or more handles 62. In the particular illustrated example, main body portion 60 is configured to look like the head of an elephant, while handles 62 are configured to look like the ears of an elephant. The illustrative and figurative aspects of cover 30 help to alleviate some or all of the stress normally associated with a child taking a medicinal product.

Delivery system 2 is used to entice, distract, tempt, or otherwise entertain the child and after garnering the attention of the child, for example with the figurative aspects of cover 30, the medication can be more easily delivered. In an alternate embodiment the cover 30 is supplemented with the messaging system 50 and thereby provides even more enticement, distraction, temptation, or entertainment to the child. In this alternate embodiment, and assuming that a message has been previously recorded within messaging device 50, otherwise a message may be recorded therein as is known in the art, the user will activate messaging device 50, e.g., through activation button 54, wherein the message will be played and heard by the child. This in turn will entice the child to more readily receive the medicine, and may entice the child to open their mouth, whereby the fluid may be dispensed through medicine dropper 12 and mouthpiece 34 disposed within trunk porting 64, which is represented by an elephants trunk in our illustrated examples. After dosing has been accomplished, the system may be dissembled for cleaning.

The head, ears and trunk of the illustrated example are configured to look like an elephant so as to be appealing to a child. However, it is to be understood that this configuration and appearance can be changed to suit any number of configurations and appearances as desired by the particular requirements of the end user. For example only, cover 30 may be configured to resemble any appealing configuration and may include other animal figures, cartoon characters, personalities, and the like. Further, it is envisioned that the recorded message could be a recording of the administrator, or the recording of, for example, a child favorite character, wherein the character's voices entices the child to take the medication.

In another embodiment, a delivery system 2 for children comprises: a medicine dropper 12, wherein the medicine dropper 12 is adapted to dispense a predefined amount of liquid into a child's mouth upon activation thereof, and a cover 30, the cover 30 adapted to be removably disposed over the medicine dropper 12 (e.g., over a stem 14). When so disposed, the medicine dropper 12 is adapted to be removably supported within the cover 30. Of course, in an alternate embodiment, a messaging system 50 may also be included therein.

In yet another embodiment, a method for providing a flowable material to a patient comprises providing a delivery system 2 including a medicinal delivery system 10 which is adapted to dispense a flowable material, and a cover 30 which is adapted to at least partially cover the medicinal delivery system 10. The medicinal delivery system 10 is then filled with a predefined amount of a flowable material, wherein the medicinal delivery system 10 is at least partially disposed within cover 30. A messaging system 50 may also be included therein and if included, may be adapted to play a prerecorded message whereby the messaging system is activated and plays the prerecorded message in the presence of the patient. The flowable material is then dispensed to the patient.

The specific configurations and features of delivery system 2 may vary according to specific requirements. In one preferred embodiment, medicinal delivery system 10 may comprise medicine dropper 12 as is generally known in the art; a cover 30 which is adapted to retain or otherwise support delivery system 10; and a small electronic audio messaging system 50 adapted to store, record, and play a message. However, the system may be adapted into numerous other configurations including, a system utilizing a single or integral delivery system and cover, a video messaging system, and a medicinal delivery system that dispenses products other than fluids. Although not meant to be limiting in any manner, one embodiment of cover 30 is moldable and manufactured from a suitable plastic material.

Further, it is also to be understood that various modifications may be made to the particular sequences, methods, and orientations which are described herein without departing from the inventive concept, and that the description contained herein is merely a preferred embodiment and hence not meant to be limiting unless stated otherwise. Further yet, it is envisioned that the style or configuration of delivery system 2 can be varied and numerous other configurations may be fabricated and, while one preferred embodiment has been described, the specific characteristics of delivery system 2 may vary according to the specific requirements of the end user.

Advantageously, the delivery system and method thereof of the present invention has, among other advantages, the ability to increase the desire of a recipient to be administered a flowable product, and increasing the effectiveness thereof while reducing the stress associated therewith. Therefore, a delivery system that solves the aforementioned disadvantages and having the aforementioned advantages has been described

The solutions offered by the invention disclosed herein have thus been attained in an economical, practical, and facile manner. To wit, a novel delivery system and method therefor which is cost effective, easily utilized, effective, and aesthetically pleasing has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

1. A delivery system for providing a flowable material comprising:
a material delivery system, the delivery system adapted to dispense a flowable material; and
a cover, the cover adapted to at least partially cover the material delivery system, the cover comprising a first side, a second side opposite the first side, and a channel extending therethrough, the channel configured to receive and support at least a portion of the material delivery system while the material delivery system dispenses flowable material;
wherein at least one of the material delivery system and the cover is adapted for oral delivery of the flowable material.

2. The delivery system according to claim 1, further comprising:
a messaging system, the messaging system adapted to play a message.

3. The delivery system according to claim 2, wherein:
the delivery system is adapted to dispense a liquid.

4. The delivery system according to claim 2, wherein:
the delivery system comprises a medicine dropper.

5. (canceled)

6. The delivery system according to claim 1, wherein:
the cover is removably disposed over the material delivery system.

7. The delivery system according to claim 6, wherein:
the delivery system comprises a stem having a first end;
the cover comprises a mouthpiece, the mouthpiece having a first end;
wherein the first end of the stem and the first end of the mouthpiece are adapted to be adjacently disposed.

8. The delivery system according to claim 1, wherein:
the delivery system comprises a stem; and
the cover is adapted to be disposed over the stem.

9. The delivery system according to claim 8, wherein further:
the cover is adapted to fully enclose the stem.

10. The delivery system according to claim 2, wherein:
the cover further comprises a mouthpiece protruding therefrom; and
the channel extends through the mouthpiece.

11. The delivery system according to claim 2, wherein:
the messaging system comprises an audio recorder.

12. A medicinal delivery system for a patient comprising:
a medicinal delivery system, the delivery system adapted to dispense a flowable material;
a cover, the cover comprising a first side, a second side opposite the first side, a mouthpiece extending from one of the first side or the second side, and a channel extending through and connecting the first and second sides and the mouthpiece, the channel adapted to removably and at least partially cover the medicinal delivery system; and
a messaging system, the messaging system adapted to play a prerecorded message upon user activation thereof, the messaging system disposed on one of the delivery system and the cover;
wherein at least one of the material delivery system and the cover is adapted for oral delivery of the flowable material.

13. The delivery system according to claim 12, wherein:
the delivery system comprises a medicine dropper.

14. The delivery system according to claim 12, wherein:
the medicine dropper comprises a stem having first end;
the mouthpiece having a first end;
wherein the first end of the stem and the first end of the mouthpiece are adapted to be adjacently disposed.

15. (canceled)

16. A medicinal delivery system for children comprising:
a medicine dropper, the medicine dropper adapted to dispense a predefined amount of liquid into a child's mouth upon activation;
a cover, the cover adapted to be at least partially and removably disposed over the medicine dropper, the cover further including a mouthpiece;
a messaging system, the messaging system adapted to play a prerecorded audio message upon activation thereof, the messaging system disposed at least partially within the cover;
wherein a user may activate the messaging system, thereby playing the prerecorded audio message, and dispense the predefined amount of liquid, through the mouthpiece of the cover, and into the child's mouth.

17. A method for providing a flowable material to a patient, the method comprising:
providing a delivery system including a medicinal delivery system adapted to dispense a flowable material, and a cover adapted to at least partially cover the medicinal delivery system, at least a portion of the cover is formed into a shape simulating a portion of a character, wherein one of the medicinal delivery system and the cover is adapted for oral delivery of the flowable material;
filling the medicinal delivery system with a predefined amount of a flowable material;
disposing the medicinal delivery system at least partially within the cover; and
dispensing the flowable material to the patient.

18. The method for providing a flowable material according to claim 17, the method further comprising:
providing a messaging system adapted to play a prerecorded message when activated by a user, the messaging system disposed on one of the medicinal delivery system or the cover; and
activating the messaging system thereby playing the prerecorded message.

19. The method for providing a flowable material according to claim 18, the method further comprising:
providing a medicinal delivery system comprising a medicine dropper, the medicine dropper further including a stern; and
providing a cover adapted to removably and fully enclose the stem.

20. The delivery system according to claim 16, wherein:
the cover is formed into a shape simulating a portion of a character.

21. The delivery system according to claim 20, wherein:
the portion of the character comprises a head of an elephant; and
the mouthpiece is formed into a shape simulating an elephant trunk.

22. The delivery system according to claim 1, wherein:
the cover is formed into a shape simulating a portion of an animal.
